(19) United States
(12) Patent Application Publication
(10) Pub. No.: US 2022/0055942 A1
(43) Pub. Date: Feb. 24, 2022

(54) GLASS FIBER AND METHOD FOR MANUFACTURING SAME

(71) Applicant: Nippon Electric Glass Co., Ltd., Shiga (JP)

(72) Inventor: Yuka TANAKA, Shiga (JP)

(21) Appl. No.: 17/312,220

(22) PCT Filed: Nov. 20, 2019
(86) PCT No.: PCT/JP2019/045412

§ 371 Date: Jun. 9, 2021

(30) Foreign Application Priority Data
Dec. 14, 2018 (JP) 2018-234076

(51) Int. Cl. C03C 13/00; C03C 3/091; C03C 3/093; C03C 3/118; C03B 37/022

(52) U.S. Cl. CPC C03C 13/00; C03C 3/091; C03B 37/022; C03C 3/118; C03C 3/093

(57) ABSTRACT

A glass fiber of the present invention includes as a glass composition, in terms of mass %, 45% to 70% of SiO₂, 0% to 20% of Al₂O₃, 10% to 35% of B₂O₃, 88% to 98% of SiO₂+Al₂O₃+B₂O₃, 0% to less than 0.7% of Li₂O+Na₂O+K₂O, 0.1% to 12% of MgO+CaO, 0% to 3% of TiO₂, and 0% to less than 0.8% of F₂, and has a mass ratio CaO/MgO of 1.0 or less.

### TECHNICAL FIELD

The present invention relates to a glass fiber and a method of manufacturing the same, and more particularly, to a glass fiber suitable as a reinforcing material for a resin member for which low-dielectric characteristics are required, such as a component for a high-speed communication device, or an automobile radar, and a method of manufacturing the same.

### BACKGROUND ART

Along with development of various electronic devices that support information industries, technologies related to information communication devices, such as a smartphone and a laptop computer, have dramatically progressed. In addition, for a circuit board for an electronic device, which is increasingly densified and increased in processing speed, low-dielectric characteristics are required so that delay in signal propagation is minimized, and heat generation of the board due to a heat loss is prevented.

Examples of the circuit board for an electronic device include a printed wiring board and a low-temperature fired board. The printed wiring board is a composite material obtained by mixing glass fibers as a reinforcing material in a resin, and forming the mixture into a sheet shape. The low-temperature fired board is a composite material obtained by firing a green sheet including glass powder and a filler.

In recent years, it has been increasingly required that a peripheral resin member of the circuit board for an electronic device achieve reductions in dielectric properties (a reduction in dielectric constant and a reduction in dielectric loss tangent), and it has been increasingly required that also glass fibers to be added as a reinforcing material for the resin member achieve reductions in dielectric properties. In particular, reductions in dielectric properties in a high-frequency band region are required. Further, also in an automobile field, along with development of an autonomous driving system, glass fibers having a low dielectric constant and a low dielectric loss tangent are required as a reinforcing material for a resin member, such as an automobile radar.

As glass fibers having low-dielectric characteristics, E glass has hitherto been generally known. However, the E glass has a dielectric constant c of 6.7 and a dielectric loss tangent tan δ of 12×10⁴ at room temperature and at a frequency of 1 MHz, and hence its low-dielectric characteristics are insufficient. In view of the foregoing, in Patent Literature 1, D glass is disclosed. For example, the D glass includes as a glass composition, in terms of mass %, 74.6% of SiO₂, 1.0% of Al₂O₃, 20.0% of B₂O₃, 0.5% of MgO, 0.4% of CaO, 0.5% of Li₂O, 2.0% of Na₂O, and 1.0% of K₂O, and has a dielectric constant of about 4.4 at room temperature and 1 MHz.

### CITATION LIST

Patent Literature 1: JP 63-2831 A
Patent Literature 2: JP 11-292567 A
Patent Literature 3: JP 2006-520314 A
Patent Literature 4: JP 2017-52974 A
Patent Literature 5: JP 2018-518440 A

### SUMMARY OF INVENTION

### Technical Problem

However, the D glass includes more than 70 mass % of SiO₂ in the glass composition, and hence its spinning temperature (temperature corresponding to a viscosity of 10^{3.0} dPa·s) is high. As a result, the D glass has drawbacks in that the lifetimes of a furnace and a bushing device are shortened. In addition, the D glass includes 3 mass % or more of alkali metal oxides (Li₂O, Na₂O, and K₂O) in the glass composition, and hence has low water resistance. As a result, the D glass has drawbacks in that its adhesiveness to a resin is reduced owing to an alkali metal component eluted from the glass, and the strength and the electrical insulation properties of a resin member as a whole are reduced.

In view of the foregoing, in each of Patent Literatures 2 to 5, there is disclosed that the contents of SiO₂ and alkali metal oxides are reduced by introducing 1 mass % or more of F₂ into a glass composition. However, when 1 mass % or more of F₂ is introduced into the glass composition, glass undergoes phase separation, and water resistance is liable to be reduced owing to the phase separation. Further, when 1 mass % or more of F₂ is introduced into the glass composition, an exhaust gas containing F₂ is generated at the time of melting, and an environmental load may be increased.

The present invention has been made in view of the above-mentioned circumstances, and a technical object of the present invention is to provide a glass fiber, which can achieve both a low spinning temperature and high water resistance while having low-dielectric characteristics, and a method of manufacturing the same.

### Solution to Problem

The inventor of the present invention has found that the above-mentioned technical object can be achieved by strictly restricting glass composition ranges, particularly by reducing the contents of alkali metal oxides and F₂ and strictly restricting the contents of CaO and MgO in a glass composition. Thus, the finding is proposed as the present invention. That is, according to one embodiment of the present invention, there is provided a glass fiber, comprising as a glass composition, in terms of mass %, 45% to 70% of SiO₂, 0% to 20% of Al₂O₃, 10% to 35% of B₂O₃, 88% to 98% of SiO₂+Al₂O₃+B₂O₃, 0% to less than 0.7% of Li₂O+Na₂O+K₂O, 0.1% to 12% of MgO+CaO, 0% to 3% of TiO₂, and 0% to less than 0.8% of F₂, and having a mass ratio CaO/MgO of 1.0 or less. Herein, the “SiO₂+Al₂O₃+B₂O₃” refers to the total content of SiO₂, Al₂O₃, and B₂O₃. The “Li₂O+Na₂O+K₂O” refers to the total content of Li₂O, Na₂O, and K₂O. The “MgO+CaO” refers to the total content of MgO and CaO. The “CaO/MgO” refers to a value obtained by dividing the content of CaO by the content of MgO.

In addition, it is preferred that the glass fiber according to the one embodiment of the present invention comprise as the glass composition, in terms of mass %, 50% to 70% of SiO₂, 0% to 20% of Al₂O₃, 10% to 30% of B₂O₃, 90% to 98% of SiO₂+Al₂O₃+B₂O₃, 0% to 0.5% of Li₂O+Na₂O+K₂O, 0.1% to 10% of MgO+CaO, 0% to 2% of TiO₂, and 0% to less than 0.5% of F₂, and have a mass ratio CaO/MgO of from 0.2 to 1.0.

In addition, it is preferred that the glass fiber according to the one embodiment of the present invention have a content of CaO+MgO of from 1 mass % to 10 mass %.

In addition, it is preferred that the glass fiber according to the one embodiment of the present invention have a content of CaO+MgO of from 3 mass % to 9 mass %.

In addition, it is preferred that the glass fiber according to the one embodiment of the present invention have a content of CaO+MgO of from 6 mass % to 8 mass %.

In addition, it is preferred that the glass fiber according to the one embodiment of the present invention have a dielectric constant at 25° C. and 1 MHz of 4.8 or less. Herein, the “dielectric constant at 25° C. and 1 MHz” is obtained through measurement in conformity with ASTM D150-87 through use of an impedance analyzer and, as a measurement sample, a glass sample piece that has been processed into dimensions of 50 mm×50 mm×3 mm and polished on the surface thereof with a #1200 alumina polishing liquid, followed by being subjected to fine annealing.

In addition, it is preferred that the glass fiber according to the one embodiment of the present invention have a temperature corresponding to a viscosity of 10^{3.0} dPa·s of 1,350° C. or less. Herein, the “temperature corresponding to a viscosity of 10^{3.0} dPa·s” refers to a value measured by a platinum sphere pull up method.

In addition, according to one embodiment of the present invention, there is provided a method of manufacturing a glass fiber, comprising: melting, in a glass melting furnace, a raw material batch blended so as to obtain glass comprising as a glass composition, in terms of mass %, 45% to 70% of SiO₂, 0% to 20% of Al₂O₃, 10% to 35% of B₂O₃, 88% to 98% of SiO₂+Al₂O₃+B₂O₃, 0% to less than 0.7% of Li₂O+Na₂O+K₂O, 0.1% to 12% of MgO+CaO, 0% to 3% of TiO₂, and 0% to less than 0.8% of F₂, and having amass ratio CaO/MgO of 1.0 or less; and continuously drawing the resultant molten glass from a bushing to form the molten glass into a fiber form.

According to one embodiment of the present invention, there is provided a glass, comprising as a glass composition, in terms of mass %, 50% to 70% of SiO₂, 0% to 20% of Al₂O₃, 10% to 30% of B₂O₃, 90% to 98% of SiO₂+Al₂O₃+B₂O₃, 0% to 0.5% of Li₂O+Na₂O+K₂O, 0.1% to 10% of MgO+CaO, 0% to 2% of TiO₂, and 0% to less than 0.5% of F₂, and having a mass ratio CaO/MgO of from 0.2 to 1.0.

### DESCRIPTION OF EMBODIMENTS

A glass fiber of the present invention comprises as a glass composition, in terms of mass %, 45% to 70% of SiO₂, 0% to 20% of Al₂O₃, 10% to 35% of B₂O₃, 88% to 98% of SiO₂+Al₂O₃+B₂O₃, 0% to less than 0.7% of Li₂O+Na₂O+K₂O, 0.1% to 12% of MgO+CaO, 0% to 3% of TiO₂, and 0% to less than 0.8% of F₂, and has a mass ratio CaO/MgO of 1.0 or less. The reasons why the contents of the components are limited are described in detail below. In the description of the content ranges of the components, the expression “%” refers to “mass %” unless otherwise specified.

SiO₂ is a component that forms the skeleton of a glass network structure, and is also a component that reduces a dielectric constant and a dielectric loss tangent. However, when the content of SiO₂ is too large, a viscosity is increased in a high temperature region, and a melting temperature and a spinning temperature are liable to be increased. Accordingly, a suitable content range of SiO₂ is from 45% to 70%, from 50% to 70%, from 50% to 65%, or from 51% to 60%, particularly from 51% to 55%.

Al₂O₃ is a component that suppresses phase separation, and is also a component that increases water resistance. However, when the content of Al₂O₃ is too large, the dielectric constant is liable to be increased. Concurrently, phase separation properties are liable to be reduced contrarily. When glass undergoes phase separation, the water resistance and the acid resistance of the glass fiber are liable to be reduced. Further, when the content of Al₂O₃ is too large, the melting temperature and the spinning temperature are increased, and the lifetimes of a furnace and a bushing are shortened. Accordingly, a suitable content range of Al₂O₃ is from 0% to 20%, from 5% to 18%, or from 8% to 17%, particularly from 10% to 16.5%.

As with SiO₂, B₂O₃ is a component that forms the skeleton of the glass network structure. In addition, B₂O₃ is also a component that reduces the melting temperature and the spinning temperature, and reduces the dielectric constant and the dielectric loss tangent. However, when the content of B₂O₃ is too large, the vaporization amount of B₂O₃ is increased at the time of melting or spinning, and the glass is liable to be heterogeneous. Further, the acid resistance is reduced, or the glass is liable to undergo phase separation. Accordingly, a suitable content range of B₂O₃ is from 10% to 35%, from 10% to 30%, from 12% to 28%, or from 15% to 27%, particularly from 17% to 25%.

A suitable content range of SiO₂+Al₂O₃+B₂O₃ is from 88% to 98%, or from 90% to 96%, particularly from 90.5% to 95%. When the content of SiO₂+Al₂O₃+B₂O₃ is too small, the contents of the other components are increased, and hence it becomes difficult to reduce the dielectric constant. Meanwhile, when the content of SiO₂+Al₂O₃+B₂O₃ is too large, the glass is liable to undergo phase separation, or the viscosity is increased in a high temperature region, and the melting temperature and the spinning temperature are liable to be increased.

MgO and CaO are each a network-modifying oxide, and are each a component that acts as a melting accelerate component and effectively reduces the viscosity in a high temperature region. Accordingly, when MgO and CaO are introduced into the glass composition, the melting temperature and the spinning temperature can easily be reduced. Concurrently, the bubble breaking properties of molten glass are improved, and homogeneous glass can easily be obtained. However, when the content of MgO+CaO is too large, the dielectric constant and the dielectric loss tangent are liable to be increased. Accordingly, a suitable content range of MgO+CaO is from 0.1% to 12%, from 1% to 12%, from 3% to 11%, from 6% to 10%, or from 6% to 9%, particularly from 6% to 8%. In the glass fiber of the present invention, MgO and CaO preferably coexist with each other in the glass composition. A suitable content range of MgO is from 0.1% to 10%, from 1% to 8%, or from 2% to 7%, particularly from 3% to 6%. A suitable content range of CaO is from 0.1% to 7%, from 0.5% to 5%, or from 1% to 4%, particularly from 2% to 3%.

A suitable range of the mass ratio CaO/MgO is 1.0 or less, from 0.2 to 1.0, or from 0.2 to 0.9, particularly from 0.3 to 0.8. When the mass ratio CaO/MgO is too high, the liquidus temperature of a Ca-based devitrified crystal, such as anorthite (CaO.Al₂O₃.2SiO₂) or wollastonite (CaO.SiO₂), is liable to be increased. In addition, the glass undergoes phase separation, and the water resistance is liable to be reduced.

Alkali metal oxides (Li₂O, Na₂O, and K₂O) are each a component that acts as a melting accelerate component and effectively reduces the viscosity in a high temperature region. However, when the content of Li₂O+Na₂O+K₂O is too large, the dielectric constant and the dielectric loss tangent are liable to be increased. In addition, the water resistance is reduced, and hence adhesiveness to a resin is liable to be reduced owing to an alkali metal component eluted from the glass. As a result, the strength and the electrical insulation properties of a resin member as a whole are liable to be reduced. Accordingly, a suitable content range of Li₂O+Na₂O+K₂O is from 0% to less than 0.7%, from 0% to 0.5%, or from 0% to less than 0.5%, particularly from 0% to 0.3%. A suitable content range of Li₂O is from 0% to less than 0.5%, or from 0% to less than 0.3%, particularly from 0% to less than 0.1%. A suitable content range of Na₂O is from 0% to less than 0.5%, or from 0% to less than 0.3%, particularly from 0% to less than 0.1%. A suitable content range of K₂O is from 0% to less than 0.5%, or from 0% to less than 0.3%, particularly from 0% to less than 0.1%.

TiO₂ is a component that reduces the dielectric loss tangent and the viscosity in a high temperature region. However, when the content of TiO₂ is too large, the glass is liable to undergo phase separation. Besides, a Ti-based devitrified crystal is liable to precipitate. Accordingly, a suitable content range of TiO₂ is from 0% to 3%, from 0% to 2%, or from 0% to 1.5%, particularly from 0.1% to 1%.

F₂ is a component that acts as a melting accelerate component and reduces the viscosity in a high temperature region. However, when the content of F₂ is too large, the glass undergoes phase separation, and the water resistance is liable to be reduced owing to the phase separation. Further, an exhaust gas containing F₂ is generated in large amount at the time of melting, and an environmental load may be increased. Accordingly, a suitable content range of F₂ is from 0% to less than 0.8%, from 0% to less than 0.5%, or from 0% to 0.4%, particularly from 0.1% to 0.4%.

In addition to the above-mentioned components, any other component may be introduced into the glass fiber of the present invention as required. For example, SrO, BaO, ZrO₂, P₂O₅, Fe₂O₃, or the like may each be introduced therein at up to 1%, and Cr₂O₃, MoO₃, Pt, Rh, NiO, or the like may each be introduced therein at up to 0.1%.

The glass fiber of the present invention preferably has the following characteristics.

The dielectric constant at 25° C. and 1 MHz is preferably 4.8 or less, 4.75 or less, or 4.7 or less, particularly preferably 4.65 or less. The dielectric loss tangent at 25° C. and 1 MHz is preferably 0.0015 or less, 0.0013 or less, 0.001 or less, 0.0007 or less, or 0.0005 or less, particularly preferably 0.0003 or less. When the dielectric constant and the dielectric loss tangent are too high, a dielectric loss is increased, and it becomes difficult to use the glass fiber as a reinforcing material for a resin member, such as a circuit board for an electronic device.

The dielectric constant at 25° C. and 1 GHz is preferably 5.0 or less, or 4.9 or less, or particularly preferably 4.8 or less. The dielectric constant at 25° C. and 20 GHz is preferably 5.0 or less, or 4.9 or less, particularly preferably 4.8 or less. When the dielectric constant in the high-frequency band region is too high, it becomes difficult to use the glass fiber for applications such as a 5G communication device and an automobile radar.

The spinning temperature (temperature corresponding to a viscosity of 10^{3.0} dPa·s) is preferably 1,350° C. or less, or 1,340° C. or less, particularly preferably 1,320° C. or less. When the spinning temperature is too high, damage to a bushing is increased, and the lifetime of the bushing is shortened. Further, a bushing exchange frequency and energy cost are increased, and the production cost of the glass fiber rises.

The liquidus temperature is preferably 1,200° C. or less, or 1,180° C. or less, particularly preferably 1,150° C. or less. When the liquidus temperature is too high, it becomes difficult to produce the glass fiber stably.

The difference between the liquidus temperature and the spinning temperature is preferably 140° C. or more, or 150° C. or more, particularly preferably 160° C. or more. When the difference between the liquidus temperature and the spinning temperature is too small, a devitrified crystal escapes at the time of spinning, and breaking of a thread is liable to occur. As a result, it becomes difficult to produce the glass fiber stably.

Subsequently, a method of manufacturing a glass fiber of the present invention is described by taking a direct melting method (DM method) as an example. However, the method of manufacturing a glass fiber of the present invention is not limited to the following description. In the method of manufacturing a glass fiber of the present invention, for example, a so-called indirect forming method (marble melting method: MM method) involving re-melting a glass material for fibers having been formed into a marble form and spinning the glass material with a bushing device may also be adopted. The MM method is suitable for production of a wide variety of products in small quantities.

First, a raw material batch is blended so as to obtain glass comprising as a glass composition, in terms of mass %, 45% to 70% of SiO₂, 0% to 20% of Al₂O₃, 10% to 35% of B₂O₃, 88% to 98% of SiO₂+Al₂O₃+B₂O₃, 0% to less than 0.7% of Li₂O+Na₂O+K₂O, 0.1% to 12% of MgO+CaO, 0% to 3% of TiO₂, and 0% to less than 0.8% of F₂, and having a mass ratio CaO/MgO of 1.0 or less. Cullet may be used as part of glass raw materials. The reasons why the contents of the components are limited as described above are as having already been described, and the description thereof is omitted here.

Next, the raw material batch blended is loaded into a glass melting furnace to be vitrified, melted, and homogenized, and the resultant molten glass is then continuously drawn from a bushing to be spun, to thereby obtain a glass fiber. A suitable melting temperature is from about 1,500° C. to about 1,600° C.

A coating agent that imparts desired physicochemical performance may be applied onto the surface of the glass fiber as required. Specifically, the glass fiber may be coated with a binder, an antistatic agent, a surfactant, an antioxidant, a film forming agent, a coupling agent, a lubricant, or the like.

Suitable examples of the coupling agent that may be used for the surface treatment of the glass fiber include γ-aminopropyltriethoxysilane, N-phenyl-γ-aminopropyltrimethoxysilane, γ-glycidoxypropyltrimethoxysilane, γ-methacryloxypropyltrimethoxysilane, γ-(2-aminoethyl)aminopropyltrimethoxysilane, β-(3,4-epoxycyclohexyl)ethyltrimethoxysilane, N-β-(N-vinylbenzylaminoethyl)-γ-aminopropyltrimethoxysilane hydrochloride, γ-chloropropyltrimethoxysilane, γ-mercaptopropyltrimethoxysilane, and vinyltriethoxysilane. The coupling agent may be appropriately selected in accordance with the kind of the resin to be compounded.

The glass fiber of the present invention is preferably used after having been processed into a chopped strand. However, other than the foregoing, the glass fiber of the present invention may be used after having been processed into a glass fiber product, such as a glass cloth, a glass filler, a glass chopped strand, glass paper, a now-woven fabric, a continuous strand mat, a knit fabric, a glass roving, or a milled fiber.

The glass fiber of the present invention may be used by being mixed with another fiber as long as the effects of the present invention are not inhibited. For example, the glass fiber of the present invention may be used by being mixed with a glass fiber, such as an E glass fiber or an S glass fiber, a carbon fiber, or a metal fiber.

A glass of the present invention comprises as a glass composition, in terms of mass %, 50% to 70% of SiO₂, 0% to 20% of Al₂O₃, 10% to 30% of B₂O₃, 90% to 98% of SiO₂+Al₂O₃+B₂O₃, 0% to 0.5% of Li₂O+Na₂O+K₂O, 0.1% to 10% of MgO+CaO, 0% to 2% of TiO₂, and 0% to less than 0.5% of F₂, and has a mass ratio CaO/MgO of 0.2 to 1.0. The technical features of the glass of the present invention have been described in the description section of the glass fiber of the present invention, and hence the detailed description thereof is omitted here.

### EXAMPLES

The present invention is hereinafter described based on Examples.

Examples (Sample Nos. 1 to 9) of the present invention and Comparative Examples (Sample Nos. 10 to 14) are shown in Table 1.

TABLE 1

| | No. 1 | No. 2 | No. 3 | No. 4 | No. 5 | No. 6 | No. 7 |
|---|---|---|---|---|---|---|---|
| SiO₂ | 53.7 | 50.0 | 53.0 | 51.9 | 52.3 | 58.0 | 59.5 |
| Al₂O₃ | 10.0 | 15.0 | 12.0 | 16.7 | 15.0 | 10.0 | 18.0 |
| B₂O₃ | 30.0 | 25.0 | 25.0 | 22.8 | 24.0 | 23.6 | 13.0 |
| Li₂O | 0.1 | 0.0 | 0.0 | 0.0 | 0.2 | 0.0 | 0.2 |
| Na₂O | 0.1 | 0.0 | 0.0 | 0.1 | 0.1 | 0.0 | 0.2 |
| K₂O | 0.1 | 0.0 | 0.0 | 0.0 | 0.1 | 0.0 | 0.1 |
| MgO | 3.0 | 8.0 | 6.5 | 5.8 | 6.0 | 4.0 | 3.6 |
| CaO | 3.0 | 2.0 | 2.5 | 2.5 | 2.1 | 3.0 | 3.5 |
| SrO | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 |
| TiO₂ | 0.0 | 0.0 | 1.0 | 0.2 | 0.2 | 1.0 | 1.5 |
| Fe₂O₃ | 0.0 | 0.0 | 0.0 | 0.0 | 0.0 | 0.0 | 0.0 |
| F₂ | 0.0 | 0.0 | 0.0 | 0.0 | 0.0 | 0.4 | 0.4 |
| Si + Al + B | 93.7 | 90.0 | 90.0 | 91.4 | 91.3 | 91.6 | 90.5 |
| Li + Na + K | 0.3 | 0.0 | 0.0 | 0.1 | 0.4 | 0.0 | 0.5 |
| Mg + Ca | 6.0 | 10.0 | 9.0 | 8.3 | 8.1 | 7.0 | 7.1 |
| Ca/Mg | 1.00 | 0.25 | 0.38 | 0.43 | 0.35 | 0.75 | 0.97 |
| ε 25° C., | Unmeasured | Unmeasured | Unmeasured | 4.63 | Unmeasured | Unmeasured | Unmeasured |
| 1 MHz | | | | | | | |
| tanδ | Unmeasured | Unmeasured | Unmeasured | 0.0003 | Unmeasured | Unmeasured | Unmeasured |
| 25° C., | | | | | | | |
| 1 MHz | | | | | | | |
| 10^{3.0} | Unmeasured | Unmeasured | Unmeasured | 1,296 | Unmeasured | Unmeasured | Unmeasured |
| dPa · s | | | | | | | |
| (° C. ) | | | | | | | |
| T_{L} (° C. ) | Unmeasured | Unmeasured | Unmeasured | 1,134 | Unmeasured | Unmeasured | Unmeasured |
| ΔT (° C. ) | Unmeasured | Unmeasured | Unmeasured | 162 | Unmeasured | Unmeasured | Unmeasured |
| | No. 8 | No. 9 | No. 10 | No. 11 | No. 12 | No. 13 | No. 14 |
| SiO₂ | 66.4 | 64.0 | 74.7 | 54.6 | 51.2 | 53.2 | 54.8 |
| Al₂O₃ | 5.0 | 7.1 | 0.5 | 16.2 | 15.0 | 15.1 | 15.0 |
| B₂O₃ | 23.0 | 25.2 | 20.2 | 20.4 | 24.3 | 19.6 | 20.7 |
| Li₂O | 0.2 | 0.1 | 0.9 | 0.7 | 0.0 | 0.2 | 0.0 |
| Na₂O | 0.2 | 0.2 | 1.5 | 0.0 | 0.1 | 0.0 | 0.0 |
| K₂O | 0.1 | 0.2 | 1.1 | 0.0 | 0.0 | 0.0 | 0.0 |
| MgO | 3.0 | 2.6 | 0.3 | 4.0 | 0.5 | 5.0 | 4.0 |
| CaO | 2.0 | 0.6 | 0.6 | 3.0 | 8.0 | 4.0 | 4.0 |
| SrO | 0.0 | 0.0 | 0.0 | 0.0 | 0.2 | 0.0 | 0.0 |
| ZrO₂ | 0.0 | 0.0 | 0.1 | 0.2 | 0.0 | 0.0 | 0.6 |
| TiO₂ | 0.0 | 0.0 | 0.1 | 0.0 | 0.3 | 2.0 | 0.0 |
| Fe₂O₃ | 0.0 | 0.0 | 0.0 | 0.0 | 0.4 | 0.1 | 0.0 |
| F₂ | 0.1 | 0.0 | 0.0 | 0.9 | 0.0 | 0.8 | 0.9 |
| Si + Al + B | 94.4 | 96.3 | 95.4 | 91.2 | 90.5 | 87.9 | 90.5 |
| Li + Na + K | 0.5 | 0.5 | 3.5 | 0.7 | 0.1 | 0.2 | 0.0 |
| Mg + Ca | 5.0 | 3.2 | 0.9 | 7.0 | 8.5 | 9.0 | 8.0 |
| Ca/Mg | 0.67 | 0.23 | 2.00 | 0.75 | 16.00 | 0.80 | 1.00 |
| ε 25° C., | Unmeasured | Unmeasured | 4.24 | 4.81 | 4.81 | 4.88 | 4.66 |
| 1 MHz | | | | | | | |
| tanδ | Unmeasured | Unmeasured | 0.0005 | 0.0017 | 0.0004 | 0.0005 | 0.0001 |
| 25° C., | | | | | | | |
| 1 MHz | | | | | | | |
| 10^{3.0} | Unmeasured | Unmeasured | 1,317 | 1,302 | 1,284 | 1,284 | 1,334 |
| dPa · s | | | | | | | |
| (° C. ) | | | | | | | |
| T_{L} (° C. ) | Unmeasured | Unmeasured | 925 | 1,124 | Unmeasurable | 1,071 | 1,099 |
| ΔT (° C. ) | Unmeasured | Unmeasured | 392 | 178 | Unmeasurable | 213 | 235 |

The samples shown in Table 1 were each prepared as described below. First, various glass raw materials, such as a natural raw material and a chemical raw material, were weighed by predetermined amounts and mixed to obtain a raw material batch. The raw material batch was then loaded into a platinum-rhodium crucible, and was heated in an indirect-heating electric furnace to provide molten glass. In order to increase the homogeneity of the molten glass, the molten glass was stirred with a heat-resistant stirring rod in the course of initial melting. The molten glass thus made into a homogenous state was poured out onto a carbon sheet to be formed into a sheet shape, and was annealed so that residual strain was removed therefrom. The resultant glass samples were each evaluated fora dielectric constant (ε) at 25° C. and 1 MHz, a dielectric loss tangent (tan δ) at 25° C. and 1 MHz, a spinning temperature (10^{3.0} dPa·s), a liquidus temperature (T_{L}), and a difference (ΔT) between the spinning temperature and the liquidus temperature. The results are shown in Table 1.

The dielectric constant and the dielectric loss tangent at 25° C. and 1 MHz were each measured for a glass sample piece obtained by processing each of the glass samples into dimensions of 50 mm×50 mm×3 mm, polishing the glass sample with a #1200 alumina polishing liquid, followed by subjecting the glass sample to fine annealing. The measurement was performed in conformity with ASTM D150-87 through use of an impedance analyzer.

The spinning temperature was measured described below. Part of each of the glass samples was crushed so as to give an appropriate size in advance, and was loaded into a crucible made of platinum and re-melted, and heated to a melt state, followed by being measured by a platinum sphere pull up method.

The liquidus temperature was measured as described below. Each of the glass samples was pulverized and adjusted to have a particle size within the range of from 300 μm to 500 μm. The glass sample in that state was filled into a refractory container so that the glass sample was in the state of having an appropriate bulk density. Subsequently, the container was introduced into a gradient heating furnace of an indirect heating type and allowed to stand still, and was subjected to heating operation for 16 hours under an air atmosphere. After that, a measurement sample was taken out from every refractory container and cooled to room temperature, and then a temperature at which a crystal initial phase precipitated was specified with a polarizing microscope. The resultant temperature was used as the liquidus temperature.

As apparent from Table 1, it is considered that each of Sample Nos. 1 to 9, in which the glass composition is strictly restricted, can achieve both a low spinning temperature and high water resistance while having low-dielectric characteristics.

Meanwhile, it is considered that Sample No. 10, in which the content of SiO₂ is high, has a high spinning temperature, and that Sample No. 10, in which the contents of alkali metal oxides are large, is liable to cause alkali elution. In addition, it is considered that each of Sample Nos. 11 and 14, in which the content of F₂ is large, has low water resistance, and has a high environmental load. It is considered that Sample No. 12, in which the mass ratio CaO/MgO is high, is liable to undergo glass phase separation, and has low water resistance. For Sample No. 12, a liquidus temperature was unmeasurable owing to phase separation. It is considered that Sample No. 13, in which the content of SiO₂+Al₂O₃+B₂O₃ is small, has a high dielectric constant, and that Sample No. 13, in which the content of F₂ is large, is liable to undergo glass phase separation, and has low water resistance.

### INDUSTRIAL APPLICABILITY

While the glass fiber of the present invention is suitable as a reinforcing material for a resin member, such as a component for a high-speed communication device, or an automobile radar, the glass fiber of the present invention may also be used for a printed wiring board application, or as a reinforcing material for a package for an electronic component, a FRP structural material, or the like. The glass of the present invention has low-dielectric characteristics and high water resistance, and is hence suitable for applications such as a cover glass and a filler.

1. A glass fiber, comprising as a glass composition, in terms of mass %, 45% to 70% of SiO₂, 0% to 20% of Al₂O₃, 10% to 35% of B₂O₃, 88% to 98% of SiO₂+Al₂O₃+B₂O₃, 0% to less than 0.7% of Li₂O+Na₂O+K₂O, 0.1% to 12% of MgO+CaO, 0% to 3% of TiO₂, and 0% to less than 0.8% of F₂, and having a mass ratio CaO/MgO of 1.0 or less.

2. The glass fiber according to claim 1, wherein the glass fiber comprises as the glass composition, in terms of mass %, 50% to 70% of SiO₂, 0% to 20% of Al₂O₃, 10% to 30% of B₂O₃, 90% to 98% of SiO₂+Al₂O₃+B₂O₃, 0% to 0.5% of Li₂O+Na₂O+K₂O, 0.1% to 10% of MgO+CaO, 0% to 2% of TiO₂, and 0% to less than 0.5% of F₂, and has a mass ratio CaO/MgO of from 0.2 to 1.0.

3. The glass fiber according to claim 1, wherein the glass fiber has a content of CaO+MgO of from 1 mass % to 10 mass %.

4. The glass fiber according to claim 1, wherein the glass fiber has a content of CaO+MgO of from 3 mass % to 9 mass %.

5. The glass fiber according to claim 1, wherein the glass fiber has a content of CaO+MgO of from 6 mass % to 8 mass %.

6. The glass fiber according to claim 1, wherein the glass fiber has a dielectric constant at 25° C. and 1 MHz of 4.8 or less.

7. The glass fiber according to claim 1, wherein the glass fiber has a temperature corresponding to a viscosity of 10^{3.0} dPa·s of 1,350° C. or less.

8. A method of manufacturing a glass fiber, comprising: melting, in a glass melting furnace, a raw material batch blended so as to obtain glass comprising as a glass composition, in terms of mass %, 45% to 70% of SiO₂, 0% to 20% of Al₂O₃, 10% to 35% of B₂O₃, 88% to 98% of SiO₂+Al₂O₃+B₂O₃, 0% to less than 0.7% of Li₂O+Na₂O+K₂O, 0.1% to 12% of MgO+CaO, 0% to 3% of TiO₂, and 0% to less than 0.8% of F₂, and having a mass ratio CaO/MgO of 1.0 or less; and continuously drawing the resultant molten glass from a bushing to form the molten glass into a fiber form.

9. A glass, comprising as a glass composition, in terms of mass %, 50% to 70% of SiO₂, 0% to 20% of Al₂O₃, 10% to 30% of B₂O₃, 90% to 98% of SiO₂+Al₂O₃+B₂O₃, 0% to 0.5% of Li₂O+Na₂O+K₂O, 0.1% to 10% of MgO+CaO, 0% to 2% of TiO₂, and 0% to less than 0.5% of F₂, and having a mass ratio CaO/MgO of from 0.2 to 1.0.

10. The glass fiber according to claim 2, wherein the glass fiber has a content of CaO+MgO of from 1 mass % to 10 mass %.

11. The glass fiber according to claim 2, wherein the glass fiber has a content of CaO+MgO of from 3 mass % to 9 mass %.

12. The glass fiber according to claim 2, wherein the glass fiber has a content of CaO+MgO of from 6 mass % to 8 mass %.

13. The glass fiber according to claim 2, wherein the glass fiber has a dielectric constant at 25° C. and 1 MHz of 4.8 or less.

14. The glass fiber according to claim 3, wherein the glass fiber has a dielectric constant at 25° C. and 1 MHz of 4.8 or less.

15. The glass fiber according to claim 4, wherein the glass fiber has a dielectric constant at 25° C. and 1 MHz of 4.8 or less.

16. The glass fiber according to claim 5, wherein the glass fiber has a dielectric constant at 25° C. and 1 MHz of 4.8 or less.

17. The glass fiber according to claim 2, wherein the glass fiber has a temperature corresponding to a viscosity of 10^{3.0} dPa·s of 1,350° C. or less.

18. The glass fiber according to claim 3, wherein the glass fiber has a temperature corresponding to a viscosity of 10^{3.0} dPa·s of 1,350° C. or less.

19. The glass fiber according to claim 4, wherein the glass fiber has a temperature corresponding to a viscosity of 10^{3.0} dPa·s of 1,350° C. or less.

20. The glass fiber according to claim 5, wherein the glass fiber has a temperature corresponding to a viscosity of 10^{3.0} dPa·s of 1,350° C. or less.
